(19) United States
(12) Patent Application Publication
(10) Pub. No.: US 2012/0018006 A1
(43) Pub. Date: Jan. 26, 2012

(54) MACHINE FOR FLUID TRANSPORTATION

(76) Inventor: Theo Nijhuis, PG Weerselo (NL)

(21) Appl. No.: 13/143,770

(22) PCT Filed: Jan. 8, 2010
(86) PCT No.: PCT/EP10/50120

§ 371 Date: Jul. 8, 2011

(30) Foreign Application Priority Data
Jan. 13, 2009 (EP) 09000357.5

(51) Int. Cl. B23P 11/00; F16K 49/00

(52) U.S. Cl. 137/15.01; 137/339

(57) ABSTRACT

A machine for fluid transportation is provided. The machine includes a fluid displacement unit, a driving unit, a common shaft which transmits torque from the driving unit to the fluid displacement unit, a common casing, a suction line and a discharge line. The flow of the fluid is divided by at least one division unit into a primary flow to be pumped or compressed and a secondary flow which is lead to internal heat sources in the casing for cooling purpose by a conduction system. A throttling device is arranged in the suction line and the division unit is arranged upstream of the throttling device on the suction line, wherein the primary and second flows are reunited downstream the throttling device.

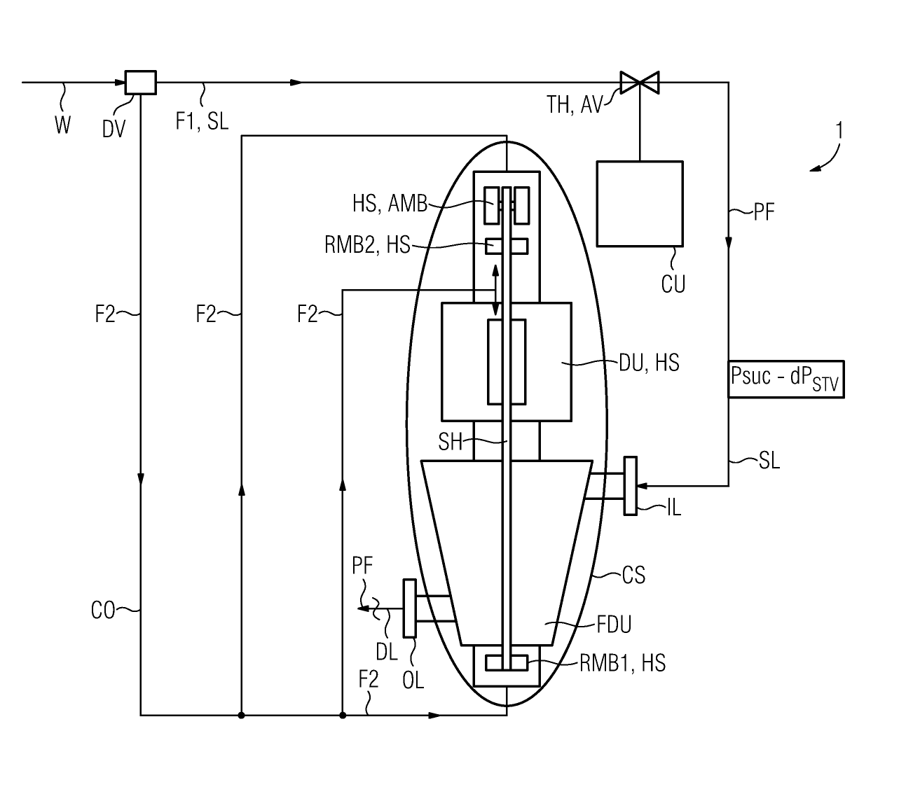

### CROSS REFERENCE TO RELATED APPLICATIONS

This application is the US National Stage of International Application No. PCT/EP2010/050120, filed Jan. 8, 2010 and claims the benefit thereof. The International Application claims the benefit of European application No. 09000357.5 EP filed Jan. 13, 2009. All of the applications are incorporated by reference herein in their entirety.

### FIELD OF INVENTION

The invention relates to a machine for fluid transportation, especially a compressor or a pump, comprising:

a fluid displacement unit, which pumps or compresses a fluid,

a driving unit, which impels the fluid displacement unit,

a common shaft, which transmits torque from the driving unit to the fluid displacement unit,

a common casing enclosing the fluid displacement unit and the driving unit,

a suction line, connected to an inlet of the casing and through which the fluid displacement unit receives a fluid to be pumped or compressed,

a discharge line, which is connected to an outlet of the casing and through which the pumped or compressed fluid is delivered,

wherein the flow is divided by at least one division unit into a primary flow to be pumped or compressed and a secondary flow, which is led to internal heat sources in the casing for cooling purpose by a conduction system.

### BACKGROUND OF INVENTION

Preferred field of application of a machine of the incipiently mentioned type is the compression of natural gas originating from a well, which is located under sea level and where the compression also takes place under sea level by the above mentioned machine. Other preferred fields of application are the compression of gas or the pumping of the fluid in an explosive environment or the compression or pumping of a toxic fluid.

The subsea application is especially interesting since an exchange of any matter respectively fluid with the environment must be strictly avoided. Therefore a specific solution must be found to cool heat sources, for example the driving unit, of the machine without fluid exchange with the environment. Since any supply from on-shore with a dedicated cooling fluid is complicated, costly and prone to error, the usage of the fluid to be compressed or pumped also for cooling is preferred.

The usage of the process fluid to cool components of the machine involves the disadvantage that all internal components must be designed to withstand the eventually chemically aggressive process fluid. In the case of the transportation of natural gas the process fluid is not only aggressive but also fluctuating in pressure, which exposes the involved components also to mechanical stress.

Further natural gas is usually contaminated by foreign particles and contains slugs of liquid and might also build up solid hydrates.

One disadvantage of the usage of the process fluid for cooling purpose is that the process fluid must be delivered to a higher pressure level before a conducting system supplies the cooling fluid to internal heat sources due to the pressure loss in the conduction system. Otherwise a flow from the process fluid respectively the cooling fluid to the heat sources would not be sufficient to obtain the desired cooling effect. This fact causes the further disadvantage, that the necessity to provide a device to increase the pressure of the cooling fluid also generated heat during the delivery to a higher pressure level, which again increases the required amount of cooling fluid.

United States patent application publication US 2007/0110596 A1 shows a pipeline compressor comprising an integrated electro motor, which is cooled by the natural gas to be compressed. From US 2007/0110596 A1 an arrangement according to the preamble of claim 1 is known. However, sufficient cooling medium flow to cool the bearings and the motor by the process gas might be difficult to establish.

### SUMMARY OF INVENTION

It is therefore one object of the invention to provide a sufficient cooling of heat sources of the machine of the incipiently mentioned type in a simple and cost efficient way, which also goes along with a high availability.

The solution for the above mentioned problem according to the invention is provided by an arrangement incorporating the features of the independent claim. The dependant claims contain features of preferred embodiments of the invention.

The arrangement of the throttling device in the suction line results in a pressure drop below the pressure level of the secondary flow so that the secondary flow after passing and cooling the heat sources of the machine can be easily reunited with the primary flow preferably at nearly the same pressure level due to pressure losses of the secondary flow in the conducting system. A significant advantage is the supply of the process fluid to the heat sources for cooling purpose with the lowest inlet temperature possible since a delivery to a higher pressure level involving also a temperature increase is not necessary according to the invention. A reunion of the secondary flow and the primary flow can easily be provided preferably upstream the fluid displacement unit. Further complicated extraction lines, which might be plugged by foreign particles, which might be carried with the primary flow, are not necessary for supplying process gas for cooling purpose to internal heat sources due to the invention.

A preferred embodiment provides an adjustable valve as the throttling device in the suction line. This way also a control unit can be provided, which controls the position of the adjustable valve depending to the temperature of the heat sources to be cooled. If the cooling demand is high, the throttling device respectively the valve can be adjusted in a more closed position and if the cooling demand is low the valve can be adjusted in a more opened respectively fully opened position. This way the pressure loss in the throttling device can be minimized and the efficiency of the machine can be increased.

One preferred embodiment of the invention provides an electric motor as the drive unit. Preferably such an electric motor belongs to the heat sources to be cooled.

In another preferred embodiment the shaft is supported by radial and axial bearings, of which at least some are magnetic bearings also to be cooled as heat sources.

Still another preferred embodiment provides the casing enclosing the shaft together with the displacement unit and the drive unit to be enclosed completely. Such a casing is preferably gas tight and since the shaft is not protruding out of the casing a rotor seal is not needed at such a location.

### BRIEF DESCRIPTION OF THE DRAWING

The above mentioned attributes and other features and advantages of this invention and the manner of attaining them will become more apparent and the invention itself will be better understood by reference to the following description of the currently best mode of carrying out the invention taken into conjunction with the accompanying drawing, wherein:

FIGURE shows a schematic depiction of a cross section of a machine according to the invention.

### DETAILED DESCRIPTION OF INVENTION

The figure shows a schematic depiction of the machine 1 according to the invention. The machine 1 comprises a fluid displacement unit FDU and a drive unit DU, which drive unit DU impels the fluid displacement unit FDU by torque transmitted over a common shaft SH. The shaft SH, the fluid displacement unit FDU and the drive unit DU are enclosed in a common casing CS. The casing CS is gas tight except for an inlet IL and an outlet OL, through which a process fluid PF flows through the machine 1. The process fluid PF is originating from a well W and led through a suction line SL to the inlet IL of the machine 1. In the suction line SL a throttling device TH is provided and upstream the throttling device TH a division unit DV is located. The throttling device TH causes a pressure difference in the suction line SL. The division unit DV divides the process fluid PF into a primary flow F1 and a secondary flow F2. The primary flow F1 is the major portion of the process fluid PF and is led through the throttling device TH. The secondary flow F2 is led through a conduction system CO to internal heat sources HS in the casing CS.

The driving unit DU is an electric motor and the shaft SH is supported by two radial bearings RMB1, RMB2 and held in an axial position by an axial bearing AMB, which bearings are all of a magnetic type. The driving unit DU, the radial bearings RMB1, RMB2 and the axial bearing AMB are all heat sources HS, to which the conduction system CO supplies portions of the secondary flow F2 of the process fluid PF for cooling purpose. Downstream the inlet IL the primary flow F1 is reunited with the secondary flow F2 before entering the fluid displacement unit FDU.

The throttling device TH is an adjustable valve AV, which is controlled by a control unit CU. The control unit CU adjusts the position of the adjustable valve AV according to the cooling demand of the heat sources HS. If the cooling demand is increasing, the control unit CU adjusts the adjustable valve AV in a more opened-position and vice versa.

1.-7. (canceled)

8. A machine for fluid transportation, comprising:
a fluid displacement unit, which pumps or compresses a fluid;
a driving unit which impels the fluid displacement unit;
a common shaft which transmits torque from the driving unit to the fluid displacement unit;
a common casing enclosing the fluid displacement unit and the driving unit;
a suction line connected to an inlet of the casing and through which the fluid displacement unit receives a fluid to be pumped or compressed;
a discharge line connected to an outlet of the casing and through which the pumped or compressed fluid is delivered;
at least one division unit for dividing a flow of the fluid into a primary flow to be pumped or compressed and a secondary flow which is led to an internal heat source in the casing for cooling purpose by a conduction system; and
a throttling device arranged in the suction line,
wherein the at least one division unit is arranged upstream of the throttling device in the suction line, and
wherein the secondary flow and the primary flow are reunited at a location downstream the throttling device.

9. The machine according to claim 8, wherein the throttling device is an adjustable valve.

10. The machine according to claim 8, wherein the driving unit is an electric motor.

11. The machine according to claim 10, wherein the electric motor belongs to the internal heat source.

12. The machine according to claim 8, wherein the common shaft is supported by magnetic bearings.

13. The machine according to claim 12, wherein the magnetic bearings belong to the internal heat sources.

14. The machine according to claim 8, wherein the common shaft is enclosed in a gas tight casing completely.

15. A method for manufacturing a machine for fluid transportation, the method comprising:
arranging a fluid displacement unit for pumping or compressing a fluid;
arranging a driving unit for impelling the fluid displacement unit;
arranging a common shaft for transmitting torque from the driving unit to the fluid displacement unit;
enclosing the fluid displacement unit and the driving unit in a common casing;
connecting a suction line to an inlet of the casing and through which the fluid displacement unit receives a fluid to be pumped or compressed;
connecting a discharge line to an outlet of the casing and through which the pumped or compressed fluid is delivered;
arranging a throttling device in the suction line;
arranging at least one division unit upstream of the throttling device in the suction line for dividing a flow of the fluid into a primary flow to be pumped or compressed and a secondary flow which is led to an internal heat source in the casing for cooling purpose by a conduction system; and
combining the secondary flow and the primary flow downstream the throttling device.

16. The method according to claim 15, comprising providing an adjustable valve as the throttling device.

17. The method according to claim 15, comprising providing an electric motor as the driving unit.

18. The method according to claim 17, comprising providing the electric as a part of the internal heat source.

19. The method according to claim 15, further comprising supporting the common shaft by magnetic bearings.

20. The method according to claim 19, comprising providing the magnetic bearings as a part of the internal heat sources.

21. The method according to claim 15, further comprising enclosing the common shaft in a gas tight casing completely
